(19) United States
(12) Patent Application Publication
(10) Pub. No.: US 2005/0008272 A1
(43) Pub. Date: Jan. 13, 2005

(54) Method and device for bearing seal pressure relief

(76) Inventors: Prashant Bhat, Manchester, NH (US); Christopher C. Langenfeld, Nashua, NH (US); Jonathan Strimling, Bedford, NH (US)

Correspondence Address: BROMBERG & SUNSTEIN LLP, 125 SUMMER STREET, BOSTON, MA, 02110-1618, US

(21) Appl. No.: 10/615,538

(22) Filed: Jul. 8, 2003

(51) Int. Cl. F16C 33/76

(52) U.S. Cl. 384/477

(57) ABSTRACT

An improvement to a sealed bearing allowing the pressure between the interior and exterior of a sealed bearing in a pressurized vessel, such as a Stirling engine, to equalize quickly. The device includes a small pressure relief hole in the bearing seal. The relief hole allows the pressure to equalize as the engine is pressurized, avoiding damage to the seal. The hole is sized so that the viscosity of the lubricant prevents leakage through the hole. Alternatively, the device may include lip seals that deform to allow the pressure to equalize.

### TECHNICAL FIELD

The present invention pertains to methods and devices for preventing damage to bearing seals in a pressurized vessel.

### BACKGROUND OF THE INVENTION

“Lube-for-life” rolling element bearings typically use a rubber lip seal to retain lubricants and to keep contaminants out. Retention of lubricant is very important for long, reliable operation of such bearings.

FIGS. 1 and 2 present double row ball bearings with seals as a typical example of rolling element bearings. FIG. 1 is an isometric view with a quarter of the outer-race removed. The inner race 15 is typically pressed onto a shaft, while the outer race 5 is pressed into a drive component such as a connecting rod. The rolling elements 20 may include, without limitation, ball, needle, cylindrical and spherical elements. The cage 25 distributes the bearings around the circumference of the races. A lubricant (not shown) is generally required between the rolling elements and the races to ensure long bearing life. The seals 10 serve to retain the grease or lubricant inside the bearing and keep contaminants, such as debris and water, out. FIG. 2 shows a cross-sectional view of the same bearing assembly.

Lube-for-life bearings may be used, for example, in the drive mechanism of engines, such as Stirling engines. These bearings may be enclosed in a pressure vessel that is subjected to very high gas pressures. Such bearings may be used in other pressurized vessels, such as those used underwater, etc. Bearing seals may form a gas-tight barrier, and prevent the bearing's interior-space pressure from equalizing with the higher-pressure engine vessel. The seal causes a pressure differential across the seal (within and outside the bearing) during pressurization with the differential equal to (P1-P2), as shown in FIG. 2. This pressure difference across the seal may deform the seal lip 35, providing a path 40 for lubricant to leak, as shown in FIG. 3. When the engine operates and turns the inner race, the deformed seal lip may be further destroyed. The lubricant can then weep out of the bearing via the leakage path 40 formed by the imploded seal. This loss of lubricant from the bearing will cause premature bearing failure.

### SUMMARY OF THE INVENTION

In an embodiment of the invention, a bearing includes a rolling element, a lubricant and a seal. The seal contains a hole that allows the internal bearing pressure to equalize with the external pressure of an engine pressure vessel containing the bearing, while the vessel is pressurized. In another embodiment of the invention, a gas-permeable membrane covers the hole. This embodiment allows for holes of greater size than the preceding embodiment. Larger size holes allow the interior and exterior pressures to equalize more quickly, allowing the engine vessel to be pressurized more rapidly.

In a further embodiment of the invention, a lip seal is provided for the bearing. The lip seal deforms to allow the internal bearing pressure to equalize with the external pressure of an engine pressure vessel containing the bearing. In a specific embodiment of the invention, two lip seals are provided that deform in opposite directions with respect to the interior of the bearing, to allow bidirectional pressure equalization. In another specific embodiment, two lip seals are provided that deform in the same directions with respect to the interior of the bearing to allow unidirectional pressure equalization.

### BRIEF DESCRIPTION OF THE DRAWINGS

The invention will be more readily understood by reference to the following description, taken with the accompanying drawings, in which:

FIG. 1 shows a view of a typical bearing assembly;

FIG. 2 shows another view of the bearing assembly of FIG. 1;

FIG. 3 shows damage to the bearing assembly of FIG. 1 as a vessel is pressurized;

FIG. 4 shows an improved bearing assembly according to embodiments of the present invention;

FIG. 5 shows an improved bearing assembly using lip seals according to another embodiment of the present invention; and

FIG. 6 shows an improved bearing assembly using lip seals according to another embodiment of the present invention.

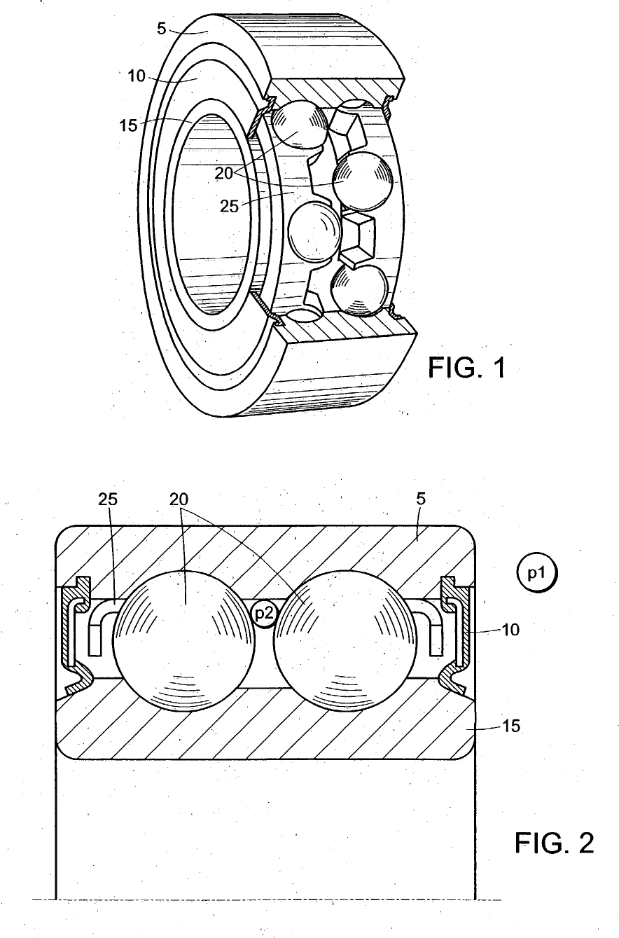

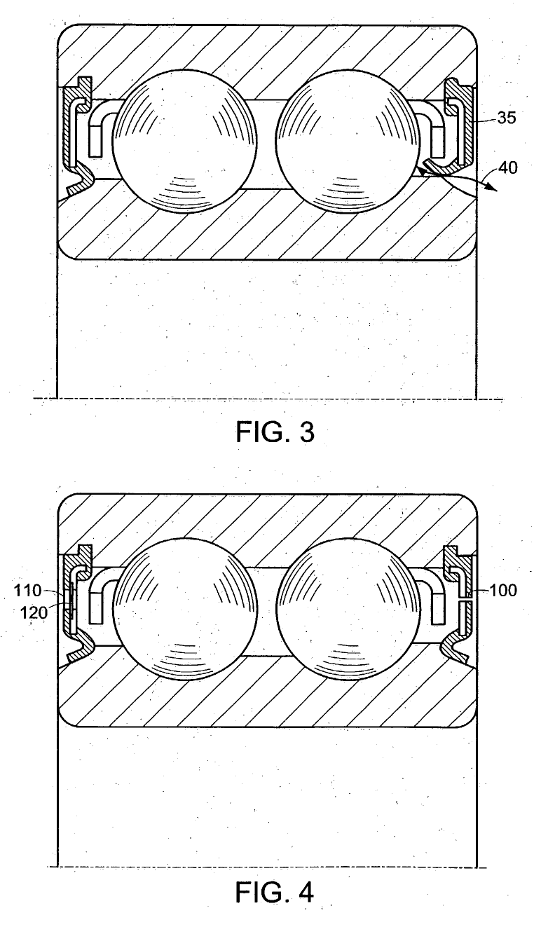

### DETAILED DESCRIPTION OF PREFERRED EMBODIMENTS

In embodiments of the present invention, seals for a rolling element bearing that allows gas leakage through the seal while effectively retaining lubricant are provided. These embodiments ensure that an engine vessel containing the bearing can be pressurized in a reasonable time without damaging the bearing seals.

As shown in FIG. 4, in a first embodiment of the invention, a bearing seal is provided with a relief hole 100. The relief hole 100 is provided in one or both of the seals of a rolling element bearing. The hole may be preferably 0.004-0.014″ in diameter if circular, or of asimilar size if non-circular. This hole allows gas to enter the bearing inner space, equalizing the pressure inside and outside the bearing. The hole prevents the seal from imploding as the engine vessel is pressurized. The lubricant continues to be constrained to the space within the bearing, since the lubricant's viscosity is high enough that the lubricant will not leak out of a hole of this approximate size. Exterior contaminants are also kept out, as the hole is small enough to form an effective shield for all but the smallest contaminants.

In another embodiment of the invention, the seal further includes a gas permeable membrane 120, such as, for example without limitation, a GORE-TEX™ membrane. The membrane covers the seal, allowing gas to flow in and out while retaining the lubricant. In this embodiment much larger holes 110, such as holes from 0.06 to 0.25″ diameter, or similarly sized holes in other shapes, may be used to allow for quicker pressure equalization than is achievable with a smaller hole. If the lubricant is sufficiently viscous, the membrane may be made of any tightly woven fabric.

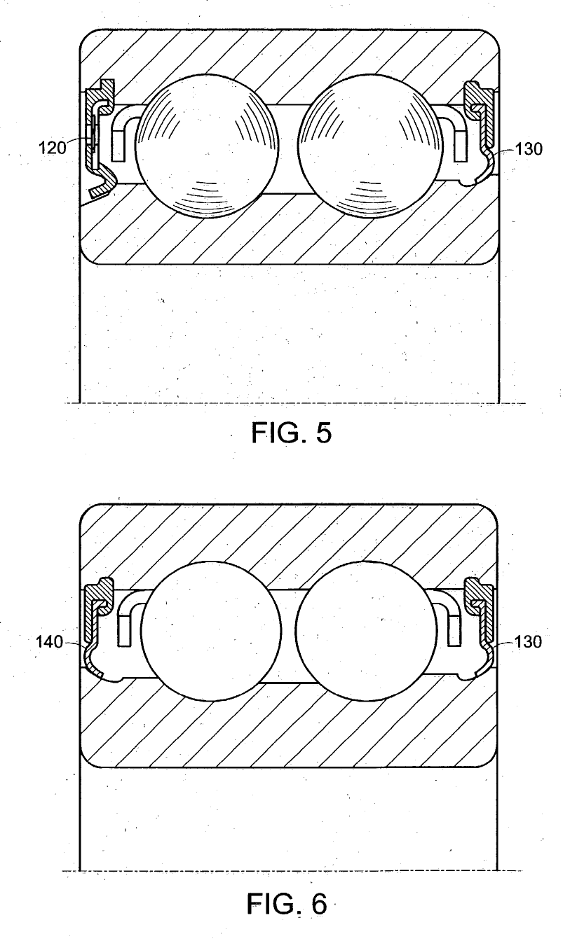

FIG. 5 shows a further embodiment of the invention employing opposed lip seals 120, 130. When pressure on the outside of the bearing is higher than the internal bearing pressure, lip seal 130 deforms inward allowing gas to pass into the bearing. Thus, the internal and external pressures equalize. When pressure on the outside of the bearing is lower than the internal bearing pressure, lip seal 120 deforms outward, allowing the internal and external pressures to equalize.

FIG. 6 shows a further embodiment of the invention that employs seals that deform inward. When pressure on the outside of the bearing is higher than the internal bearing pressure, both lip seals 130, 140 deform inward allowing gas to pass into the bearing. This embodiment may be used advantageously, for example, where a system is charged for life and depressurization of the system is not anticipated.

The described embodiments of the invention are intended to be merely exemplary and numerous variations and modifications will be apparent to those skilled in the art. All such variations and modifications are intended to be within the scope of the present invention as defined in the appended claims.

1. In a pressurized vessel including a bearing, the bearing disposed interior to the vessel, the bearing comprising a rolling element and a seal, an improvement comprising a hole in the seal for allowing the bearing internal pressure to equalize with the vessel pressure.

2. An improvement according to claim 1 wherein the hole in the seal is less than 0.014 inches in diameter and greater than 0.004 inches in diameter.

3. An improvement according to claim 1, further comprising a gas-permeable membrane substantially covering the hole in the seal.

4. An improvement according to claim 3, wherein the hole in the seal is greater than 0.06 inches in diameter.

5. A method for minimizing a pressure differential between the interior of a bearing and the exterior of the bearing in a pressurized vessel, the method comprising:
a. providing the pressurized vessel including a bearing disposed therein, the bearing including a rolling element and a seal; and
b. making a hole in the seal.

6. A method according to claim 5, further comprising:
c. covering the hole in the seal with a gas-permeable membrane.

7. In a bearing for use in a pressurized vessel, the bearing including a rolling element and a seal, an improvement comprising a first lip seal that deforms such that the bearing internal pressure equalizes with the vessel pressure.

8. A bearing according to claim 7, wherein the first lip seal deforms toward the interior of the bearing when the vessel pressure is higher than the bearing interior pressure.

9. A bearing according to claim 7, the improvement further comprising a second lip seal that deforms such that the bearing internal pressure equalizes with the vessel pressure.

10. A bearing according to claim 9 wherein the first lip seal and the second lip seal deform in opposite directions with respect to the interior of the bearing.

11. A bearing according to claim 9 wherein the first lip seal and the second lip seal deform in the same direction with respect to the interior of the bearing.

12. A method for minimizing a pressure differential between the interior of a bearing and the exterior of the bearing, the method comprising:
a. providing the bearing for use in a pressurized vessel, the bearing including a rolling element and a lubricant;
b. installing a first lip seal to retain the lubricant in the bearing, the lip seal shaped to deform so that the pressure differential decreases.

13. A method according to claim 13, further comprising:
c. installing a second lip seal to retain the lubricant in the bearing, the second lip seal shaped to deform in a direction that is opposite to the direction of deformation of the first lip seal.

14. In a bearing for use in a pressurized vessel, the bearing including a rolling element, a lubricant and a seal, an improvement comprising a hole in the seal and a gas-permeable membrane substantially covering the hole in the seal for allowing the bearing internal pressure to equalize with the vessel pressure.

15. A bearing according to claim 14, wherein the hole in the seal is greater than 0.06 inches in diameter.

16. A method for minimizing a pressure differential between the interior of a bearing and the exterior of the bearing, the method comprising:
a. providing the bearing for use in a pressurized vessel, the bearing including a rolling element, a lubricant and a seal;
b. making a hole in the seal; and
c. covering the hole in the seal with a gas-permeable membrane.
